(19) United States
(12) Patent Application Publication
(10) Pub. No.: US 2005/0080973 A1
(43) Pub. Date: Apr. 14, 2005

(54) PERIPHERAL DEVICE HAVING A PERSONAL DISK USED FOR STORING DEVICE DRIVERS AND DRIVING METHOD THEREOF

(76) Inventor: Kuei-Jung Lee, Taipei Hsien (TW)

Correspondence Address: NORTH AMERICA INTERNATIONAL PATENT OFFICE (NAIPC), P.O. BOX 506, MERRIFIELD, VA, 22116, US

(21) Appl. No.: 10/711,196

(22) Filed: Sep. 1, 2004

Related U.S. Application Data
(63) Continuation-in-part of application No. 10/605,455, filed on Sep. 30, 2003.

(51) Int. Cl. G06F 13/36; G06F 13/38

(52) U.S. Cl. 710/311

(57) ABSTRACT

A peripheral device having a personal disk used for storing device drivers. The peripheral device can be connected to an interface port of an electronic device host. The peripheral device has a housing, an application module for performing a predetermined operation, a storage module for storing a device driver of the application module, and a hub controller electrically connected to the application module and the storage module. When the hub controller is electrically connected to the interface port, the computer host can retrieve the device driver of the application module through the hub controller, and can automatically install and run the device driver to control the application module to perform the predetermined operation.

### CROSS REFERENCE TO RELATED APPLICATIONS

This is a continuation-in-part of U.S. Application No. 10/605,455, filed 30 SEP., 2003, which is incorporated herein by reference.

### BACKGROUND OF INVENTION

1. Field of the Invention

A peripheral device having a personal disk used for storing device drivers and a driving method thereof. The peripheral device is capable of being connected to an interface port of a computer host. The peripheral device has a housing, an application device for performing a predetermined operation, a storage device for storing a device driver of the application device, and a Hub controller electrically connected to the application device and the storage device. When the Hub controller is electrically connected to the interface port, the computer host is capable of retrieving the device driver of the application device through the Hub controller and also capable of running and automatically installing the device driver to control the application device to perform the predetermined operation.

2. Description of the Prior Art

In order to support plug & play functionality and high data transmission speed required by customers, new peripheral interfaces such as the universal serial bus (USB) interface and the IEEE1394 interface have gradually taken the place of the old-fashioned parallel port and the serial port. The USB interface was established by many companies such as Intel®, Compaq®, Digital®, Microsoft®, and NECO in 1993. It is well known that one USB port is capable of connecting up to 127 peripheral devices, and all of the peripheral devices share the same bus bandwidth. Furthermore, a peripheral device compatible with the USB specification can be directly connected to a currently booted computer host. That is, the USB-compatible peripheral device supports hot swap functionality. With regard to the IEEE1394 interface, one IEEE1394 bus is capable of supporting up to 63 peripheral devices. Similarly, the IEEE1394-compatible peripheral device supports the above-mentioned hot swap functionality as well. Therefore, the users can conveniently install peripheral devices onto the computer host through a USB port or an IEEE1394 port positioned on the computer host.

Please refer to FIG. 1, which is a block diagram of a prior art computer system 10. The computer system 10 has a computer host 12, and the computer host 12 includes a central processing unit (CPU) 14, a north bridge circuit 16, a south bridge circuit 18, a display driving circuit 20, a memory 22, an optical disk drive 24, a hard disk drive 26, and a monitor 28. The CPU 14 is used to control overall operation of the computer system 10. The north bridge circuit 16 is used to control data transmission between the CPU 14 and high-speed devices such as the display driving circuit 20 and the memory 22. The south bridge circuit 18 is used to control data transmission between the south bridge circuit 16 and low-speed devices such as the optical disk drive 24 and the hard disk drive 26. The display driving circuit 20 is used for 2D graphic processing and 3D graphic processing, and generating video signals for driving the monitor 28 to show corresponding image frames. As mentioned above, the user can install peripheral devices onto the computer host 12 through a USB port or an IEEE1394 port.

Take the USB port for example. The south bridge circuit 18 has a USB host controller 30 for controlling data transmitted via a USB bus. Suppose that the USB host controller 30 itself only supports two ports 32a, 32b, but the user desires to use more that three peripheral devices on the computer system 10. Therefore, a USB hub 33 is necessary to provide more ports 34a, 34b, 34c. Please note that ports 32a, 32b are downstream ports for the USB host controller 30 to connect external peripheral devices. Similarly, in the USB hub 33, ports 34b, 34c are also downstream ports used for connecting external peripheral devices. However, port 34a of the USB hub 33 is an upstream port, and is used for connecting to either port 32a or the port 32b. As shown in FIG. 1, port 34a is electrically connected to the port 32b. Therefore, the peripheral devices connected to the ports 34b, 34c can deliver data to the USB host controller 30 or receive data from the USB host controller 30 through the connection between port 34a and port 32b. Because the USB hub 33 provides a plurality of ports 34b, 34c, the goal of increasing a total amount of connectible peripheral devices is achieved. From FIG. 1, a keyboard 36 is connected to port 32a for the user to input keyboard signals to the computer host 12. In addition, with the help of the USB hub 33, a personal disk 38 is capable of being connected to the port 34c, and a WLAN module 40 can be connected to the port 34b. That is, three peripheral devices have been successfully installed on the computer host 12.

After the computer system 10 is powered on, the computer system 10 starts a power-on-self-test (POST) process. Then, an operating system (OS) is loaded. When the CPU 14 runs the OS, the OS loads device drivers according to the hardware components installed within the computer system 10 for controlling operations of the hardware components. For instance, a display driver is used to control the display driving circuit 20 to process image data and generate video signals for driving the monitor 28. In other words, when a new hardware component is installed on the computer system 10, the user needs to do a corresponding device driver installation so that the OS is capable of driving the added hardware component correctly. For example, the WLAN module 40 is connected to the port 34b through a hot swap operation. Suppose that the WLAN module 40 has never been installed on the computer system 10 before. That is, the WLAN module 40 is a newly added hardware component to the computer system 10. If the OS is unable to find a device driver suitable for this unknown WLAN module 40, the OS shows a dialog window on the monitor 28 to ask the user about a target location of the wanted device driver for the WLAN module 40. Then, the user inserts an optical disk having the required device driver into the optical disk drive 24. In the end, the OS loads the device driver of the WLAN module 40, and the device driver is stored on the hard disk drive 26. In addition, information associated with the WLAN module 40 and the corresponding device driver is recorded by a registry file of the OS. Therefore, when an identical WLAN module 40 is installed on the computer system 10 again, the WLAN module 40 is no longer an unfamiliar hardware component for the computer system 10 because the device driver installation has been done previously, and the registry file of the OS has kept the registry codes related to the WLAN module 40. Therefore, the OS can directly load the wanted device driver stored on the hard disk drive 26 through the information provided by the registry file, and the WLAN module 40 is controlled correctly.

As mentioned above, when the user installs a new hardware component such as the WLAN module 40 onto the computer system 10 through one of the ports 32a, 32b, 32c, the user needs to do a device driver installation if the OS of the computer system 10 does not support this new hardware component yet. That is, the manufacturer of the WLAN module 40 has to provide the user with either an optical disk or a magnetic disk that contains the required device driver. However, if the user loses the optical disk or the magnetic disk that stores the device driver, the WLAN module 40 cannot function normally on the computer system 10 until after the user recovers the lost optical disk or the lost magnetic disk. Furthermore, if the user wants to use the same WLAN module 40 on different computer devices, the user has to carry either the optical disk or the magnetic disk storing the device driver so as to perform the device driver installation for each of the computer devices. In summary, because a device driver of a peripheral device is stored on either one optical disk or one magnetic disk without being combined with the peripheral device, the user needs both the peripheral device and the device driver to successfully apply the peripheral device on one computer device. However, it is not convenient for the user to carry and keep the device driver. Therefore, the utilization of the prior art peripheral device is not convenient for the user.

### SUMMARY OF INVENTION

It is therefore a primary objective of this invention to provide a peripheral device having a personal disk used for storing device drivers.

Briefly summarized, the preferred embodiment of the present invention discloses a peripheral device capable of being connected to an interface port on an electronic device host. The peripheral device has a housing, an application module positioned at least partially inside the housing, a storage module positioned inside the housing for storing a device driver of the application module, and a hub controller positioned inside the housing and electrically connected to the application module and the storage module. When the hub controller is electrically connected to the interface port, the electronic device host is capable of retrieving the device driver stored by the storage module and running the device driver to operate the application module.

The present invention further discloses a peripheral device capable of being connected to an interface port on an electronic device host. The peripheral device has a housing, an application module positioned at least partially inside the housing; a storage module positioned inside the housing for storing a device driver of the application module and a firmware that can drive the storage module to simulate an autorun function of an optical disc drive; and a hub controller positioned inside the housing, the hub controller being electrically connected to the application module and the storage module; wherein when the hub controller is electrically connected to the interface port, the electronic device host is capable of retrieving the device driver stored by the storage module and running the device driver to operate the application module.

The present invention further discloses a method of driving a peripheral device. The peripheral device is capable of being connected to an interface port on an electronic device host and comprises an application module, a storage module, and a hub controller. The method comprises: connecting the peripheral device and the interface port; enabling the hub controller for controlling data transmission among the application module, the storage module, and the electronic device host; enabling the storage module; utilizing the electronic device host for retrieving a device driver of the application module from the storage module through the hub controller; and running the device driver to operate the application module.

The present invention further discloses a method of driving a peripheral device. The peripheral device is capable of being connected to an interface port on an electronic device host and comprises an application module, a storage module, and a hub controller. The method comprises: connecting the peripheral device and the interface port; enabling the hub controller for controlling data transmission among the application module, the storage module, and the electronic device host; enabling the storage module; having the storage device execute the firmware to drive the storage device for simulating an autorun function of an optical disc drive to install the driver of the application device in the electronic device host; and running the device driver to operate the application module.

The present invention further discloses a peripheral device capable of being connected to an interface port of an electronic device host, the peripheral device comprising: a connector having a plurality of pins for connecting the interface port of the electronic device host; a hub controller electrically connected to the connector; an application module electrically connected to the hub controller; and a storage module electrically connected to the hub controller for storing data.

The present invention further discloses a peripheral device capable of being connected to an interface port of a host, the peripheral device comprising: a connector having a plurality of pins for connecting the interface port of the host; a hub controller electrically connected to the connector; and a storage module electrically connected to the hub controller for storing data; wherein the storage module stores a device driver of the peripheral device in advance, and the host retrieves the device driver from the storage module when the peripheral device is connected to the interface port for a first time.

The present invention further discloses a data access system comprising: an electronic device host and a peripheral device capable of being connected to an interface port of the electronic device host. The peripheral device comprises: a housing; an application module for accessing data; a storage module positioned inside the housing; and a hub controller positioned inside the housing. The hub controller is electrically connected to the application module and the storage module and is electrically connected to the interface port. The electronic device host is capable of retrieving the data through the hub controller and is capable of transferring the data to the storage module through the hub controller for storing the data in the storage module.

It is an advantage of the present invention that the claimed peripheral device combines a personal-disk-like device set up in an application module. When the user carries the claimed peripheral device, a device driver of the application module travels along with the application module. Therefore, the inconvenience caused by the device driver being stored in an optical disk or a magnetic disk is solved. The personal disk itself is a storage module, and a manual of the application module or software applications of the application module can be stored in the personal disk. Therefore, consumption of optical disks, magnetic disks, and paper is reduced. At the same time, the cost is accordingly lowered. The claimed peripheral device has a hub controller so that both the personal disk and the application module share the same port. Therefore, the computer host is capable of having more ports available to other external devices. In addition, the claimed peripheral device also has switches used for control power supply of the personal disk and the application module according to user's demands so that the power consumption associated with the claimed peripheral device is greatly reduced.

These and other objectives of the present invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a block diagram of a prior art computer system.

FIG. 2 is a perspective diagram of a peripheral device according to the present invention.

FIG. 3 is a block diagram of the first embodiment of the peripheral device according to the present invention.

FIG. 4 is a flow chart illustrating operation of the peripheral device shown in FIG. 3.

FIG. 5 is a block diagram of the second embodiment of the peripheral device according to the present invention.

FIG. 6 is a flow chart illustrating operation of the peripheral device shown in FIG. 5.

FIG. 7 is a block diagram of the third embodiment of the peripheral device according to the present invention.

FIG. 8 is a flow chart illustrating operation of the peripheral device shown in FIG. 7.

### DETAILED DESCRIPTION

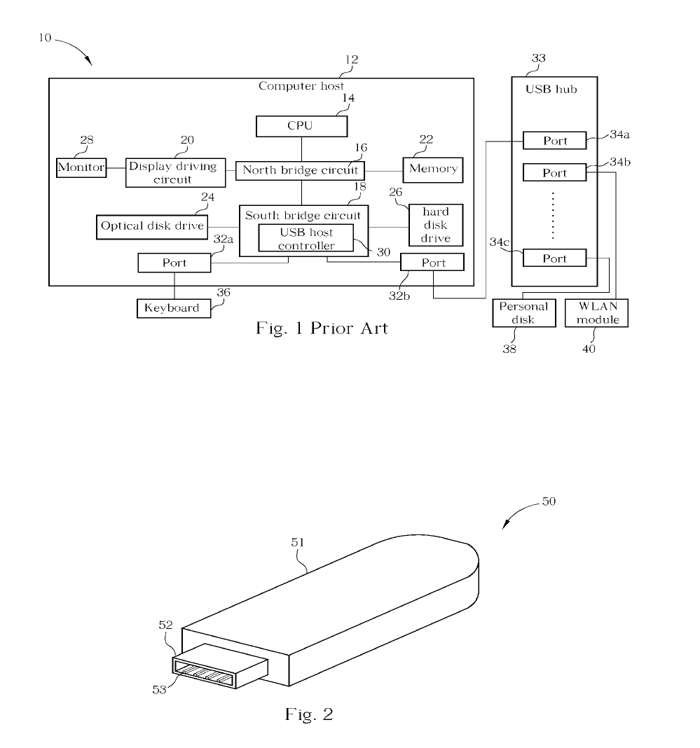

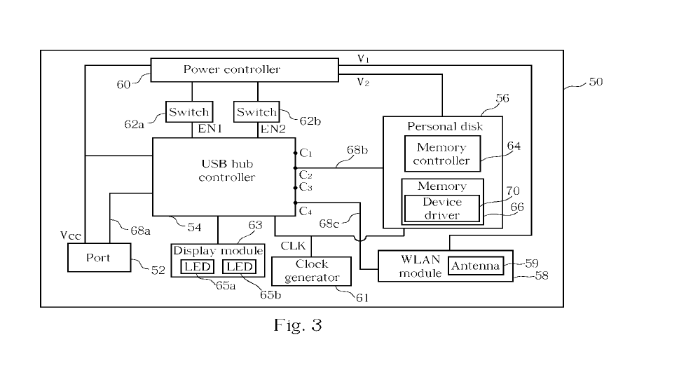

Please refer to FIG. 2 in conjunction with FIG. 3. FIG. 2 is a perspective diagram of the peripheral device 50 according to the present invention, and FIG. 3 is a block diagram of the first embodiment of the peripheral device 50 according to the present invention. The peripheral device 50 has a housing 51 and a port 52. The housing 51 is used to protect internal components of the peripheral device 50. The port 52 is used to connect an interface port of an electronic device such as a computer host so as to install the peripheral device 50 on the electronic device. With regard to the peripheral device 50, the port 52 is a male connector, and the port 52 has a plurality of pins 53. Therefore, the interface port is required to be a female connector for connecting the port 52 successfully. As shown in FIG. 3, the peripheral device 50 includes the port 52, a USB hub controller 54, a personal disk 56, a WLAN module 58, a power controller 60, a clock generator 61, switches 62a, 62b, and a display module 63. The personal disk 56 has a memory controller 64 and a memory 66(NAND or NOR flash memories can be used). In the preferred embodiment, hardware components such as the USB hub controller 54, the personal disk 56, the WLAN module 58, the power controller 60, and switches 62a, 62b are positioned inside the housing 51 with the exception of the port 52. That is, the housing 51 is capable of protecting these above-mentioned internal hardware components from being damaged by external shock.

Suppose that the peripheral device 50 is capable of being installed on the computer host 12 shown in FIG. 1. As shown in FIG. 1, the computer host 12 has ports 32a, 32b. The port 52 is capable of being connected to either the port 32a or the port 32b so as to install the peripheral device 50 on the computer host 12. For example, the ports 32a, 32b are USB female connectors, and the port 52 is a corresponding USB male connector. Therefore, the port 52 can be directly connected to either the port 32a or the port 32b. In addition, the port 52 also can be connected to either the port 32a or the port 32b by means of a well-known USB extended cable. The port 52 in the preferred embodiment functions as an upstream port, and is connected to the USB hub controller 54 through a data channel 68a. Further, when the port 52 is connected to the port 32b of the computer host 32, it is well-known that the computer host 12 outputs an operating voltage Vcc from the port 32b to the corresponding port 52. Then, the received operating voltage Vcc is further passed to the USB hub controller 54 and the power controller 60. The USB hub controller 54 itself supports a plurality of downstream ports. In the preferred embodiment, the USB hub controller 54 supports only 4 input/output ports (I/O ports) C1, C2, C3, C4, wherein the I/O port C2 is connected to the personal disk 56 through a data channel 68b, and the I/O port C4 is connected to the WLAN module 58 through a data channel 68c. The USB hub controller 54, however, is capable of coordinating the personal disk 56 and the WLAN module 58 to share the common data channel 68a for delivering and receiving data. In addition, the memory controller 64 is used to control data access of the memory 66, and the memory 66 is a non-volatile memory such as a flash memory. Furthermore, the memory 66 stores a device driver 70 of the WLAN driver 58.

In the preferred embodiment, an application module of the peripheral device 50 is capable of being at least partially positioned inside the housing 51. Taking the WLAN module 58 for example, it is partially positioned inside the housing 51 owing to an antenna 59 protruding from the housing 51 for transmitting and receiving radio frequency (RF) signals. However, the main body of the WLAN module 58 is still protected by the housing 51. The WLAN module 58 is used to access a computer network via wireless transmission. For example, a plurality of computer devices that have the WLAN modules 58 can access one wireless network via an access point. The switch 62a is used to determine if an enabling signal EN1 outputted from the USB hub controller 54 is delivered to the power controller 60. If the power controller 60 receives the enabling signal EN1, the power controller 60 outputs one driving voltage V1 to the WLAN module 58 so that the WLAN module 58 can function normally. In the preferred embodiment, the driving voltage V1 is equal to the operating voltage Vcc. In addition, the switch 62b is used to determine if an enabling signal EN2 outputted from the USB hub controller 54 is delivered to the power controller 60. If the power controller 60 receives the enabling signal EN2, the power controller 60 outputs another driving voltage V2 to the personal disk 56 so that the personal disk 56 can function normally. In the preferred embodiment, the driving voltage V2 is equal to the operating voltage Vcc as well. According to user's demands, the switches 62a, 62b are capable of being controlled to determine whether the WLAN module 58 and the personal disk 56 are powered to perform their functionality. To sum up, the personal disk 56 and the WLAN module 58 are respectively connected to the USB hub controller 54 through a predetermined interface. Therefore, the USB hub controller 54 is capable of controlling data transmission and driving voltages of the personal disk 56 and the WLAN module 58.

The clock generator 61 in the preferred embodiment is used for outputting a driving clock CLK. For instance, the clock generator 61 is a crystal oscillator used to generate the driving clock CLK with a predetermined frequency. If the peripheral device 50 conforms to the USB 1.1/2.0 specification, the maximum data transfer rate is 12 Mbps/480 Mbps. Therefore, the clock generator 61 can be implemented by a crystal oscillator that is capable of outputting the driving clock CLK having a frequency equaling 12M/480M. Because the USB hub controller 54 is edge-triggered by the driving clock CLK, the USB hub controller 54 is triggered by rising edges of the driving clock CLK; for example, the maximum data transfer rate associated with the USB hub controller 54 is equal to 12 Mbps to meet the requirement defined by the USB 1.1/2.0 specification. Furthermore, the clock generator 61 shown in FIG. 3 is simultaneously connected to the USB hub controller 54 and the personal disk 56. The same driving clock CLK, therefore, drives both the USB hub controller 54 and the personal disk 56. That is, the claimed peripheral device 50 only having one clock generator 61 is capable of achieving the goal of driving the USB hub controller 54 and the personal disk 56. In other words, the claimed peripheral device 50 can reduce its chip size and its production cost with the clock generator 61 jointly utilized by the USB hub controller 54 and the personal disk 56.

In the preferred embodiment, the display module 63 has two light emitting diodes (LEDs) 65a, 65b used for informing the user of current operating statuses associated with the personal disk 56 and the WLAN module 58. For instance, when the personal disk 56 and the USB hub controller 54 are successfully connected, the LED 65a is enabled. Similarly, when the WLAN module 58 and the USB hub controller 54 are successfully connected, the LED 65b is enabled as well. Therefore, the user can verify whether the personal disk 56 and the WLAN module 58 function correctly by watching the LEDs 65a, 65b.

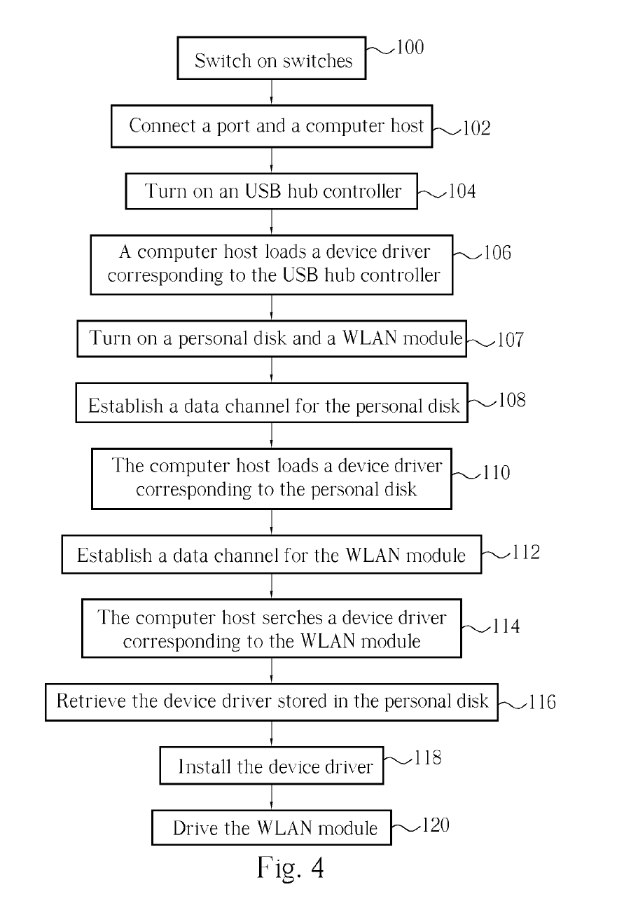

Please refer to FIG. 4 in conjunction with FIGS. 1 and 3. FIG. 4 is a flow chart illustrating operation of the peripheral device 50 shown in FIG. 3. The operation of the peripheral device 50 is described as follows. The peripheral device 50 can be installed on the computer host 12 such as a desktop computer, a notebook computer, or a personal digital assistant to expand functionality of the original computer host 12. If the peripheral device 50 is a new hardware component for the computer host 12, that is, the peripheral device 50 has never been installed on the computer host 12 before, the user needs to switch on the switches 62a, 62b so that the enabling signals EN1, EN2 are successfully transferred to the power controller 60 (step 100). Then, the port 52 is connected to the computer host 12. It is well-known that the ports 32a, 32b of the computer host 12 are female connectors. With the port 52 being a male connector, it can be directly inserted into either the port 32a or the port 32b. Otherwise, the port 52 of the peripheral device 50 can be connected to one of the ports 32a, 32b through a USB extended cable (step 102). After the peripheral device 50 is electrically connected to the computer host 12, the USB host controller 30 outputs the operating voltage Vcc (5V) to the USB hub controller 54 and the power controller 60 in the peripheral device 50. Concerning the USB hub controller 54, the USB hub controller 54 starts working after receiving the operating voltage Vcc (step 104).

With regard to the power controller 60, the power controller 60 does not output the driving voltages V1, V2 that equal the operating voltage Vcc because the USB hub controller 54 does not trigger the enabling signals EN1, EN2 yet. After the USB hub controller 54 is turned on, the data channel 68a is established between the USB hub controller 54 and the USB host controller 30 for transmitting data. For instance, the USB hub controller 54 delivers hardware parameters to the USB host controller 30 so that the OS run on the computer host 12 is capable of detecting the added USB hub controller 54. Generally speaking, current operating systems such as Win 2000® and WinXP® already include the device driver of the USB hub controller 54. Therefore, the device driver of the USB hub controller 54 is successfully loaded to control the operation of the USB hub controller 54 (step 106). Because the operating voltage Vcc has been inputted into the USB hub controller 54 to activate the USB hub controller 54, the USB hub controller 54 starts triggering the enabling signal EN1, EN2 to drive the power controller 60 for outputting the driving voltages V1, V2 to the personal disk 56 and the WLAN module 58 (step 107). Please note that the data channel 68b between the personal disk 56 and the USB hub controller 54 and the data channel 68c between the WLAN module 58 and the USB hub controller 54 are not established yet though the driving voltages V1, V2 have been inputted into the personal disk 56 and the WLAN module 58. In other words, the USB hub controller 54 at this point does not enable the I/O port C2 corresponding to the personal disk 56 and the I/O port C3 corresponding to the WLAN module 58.

In the preferred embodiment, the USB hub controller 54 supports 4 downstream ports respectively corresponding to the I/O ports C1, C2, C3, C4. It is well-known that the USB hub controller 54 sequentially enables downstream ports. In other words, the USB hub controller 54 first enables the I/O port C1 for establishing a corresponding data channel between the I/O port C1 and a device connected to the I/O port C1. Then, the USB hub controller 54 enables the I/O port C2 for establishing a corresponding data channel between the I/O port C2 and a device connected to the I/O port C2 and so on. According to the I/O port sequence, the USB hub controller 54 finally enables the last I/O port C4 for establishing a corresponding data channel between the I/O port C4 and a device connected to the I/O port C4. The personal disk 56 is connected to the I/O port C2, and the WLAN module 58 is connected to the I/O port C4. Therefore, the USB hub controller 54 first enables the I/O port C2 to establish the data channel 68b between the USB hub controller 54 and the personal disk 56 (step 108). Now, the OS run by the computer host 12 detects the personal disk 56. Because currently popularized operating systems such as Win 2000® and WinXP® support the personal disk 56, the embedded device driver for the personal disk 56 is successfully loaded to control the operation of the personal disk 56 (step 110). Because the WLAN module 58 is connected to the I/O port C4, the USB hub controller 54 enables the I/O port C4 for establishing the data channel 68c between the WLAN module 58 and the USB hub controller 54 after the data channel 68b has been established (step 112).

Now, the OS run by the computer host 12 detects the WLAN module 58. However, the OS does not support the specific WLAN module 58. Therefore, the OS is unable to find a device driver suitable for the WLAN module 58 from the device drivers embedded in the OS. Generally speaking, the OS displays a dialog window to ask the user to provide the required device driver (step 114). Please note that the OS has executed the device driver of the personal disk 56 to control the operation of the personal disk 56 successfully. Therefore, a disk drive number is assigned to the personal disk 56. That is, the personal disk 56 accessed through the OS is like that of the hard disk drive 26 or the optical disk drive 24. In addition, the personal disk keeps the device driver 70 of the WLAN driver 58. Therefore, the user can direct the OS to retrieve the wanted device driver 70 from the personal disk 56. For example, suppose that the personal disk 56 corresponds to a disk drive number H in the OS. When the OS displays a dialog window to ask the user to manually provide the required device driver, the user locates the disk drive number H through operating the dialog window, and inputs the file name of the device driver 70 to inform the OS of the location associated with the device driver 70. Then, the OS starts installing the device driver 70 (step 118), and one copy of the device driver 70 is recorded on the hard disk drive 26. At the same time, hardware information of the WLAN module 58 and software information of the device driver 70 is recorded in a registry file. After the OS successfully loads the device driver 70, the computer host 12 is capable of driving the WLAN module 58 to perform a predetermined operation (step 120).

Because the personal disk 56 is used to store the device driver 70 of the WLAN module 58, the I/O port corresponding to the personal disk 56 has to be enabled before the I/O port corresponding to the WLAN module 58 so that the personal disk 56 can be used to successfully install the device driver 70. In other words, if the personal disk 56 is connected to the I/O port C1, then the WLAN module 58 can be connected to the I/O port C2, the I/O port C3, or the I/O port C4. The same goal of installing the device driver 70 through the personal disk 56 is achieved. The personal disk 56 itself is a memory device. Therefore, not only is the device driver 70 stored, but also any kind of data can be stored by the personal disk 70. For instance, the computer host 12 correctly drives the personal disk 56 and the WLAN module 58 in the peripheral device 50 after the above-mentioned steps are completed. If the user runs an application on the computer host 12 for retrieving a document file shared on a computer network, the computer host 12 can control the WLAN module 58 to retrieve the wanted document file. Then, the user opens this document file to edit it, and saves the edited document file to the memory 66 of the personal disk 56. The computer host 12 no longer stores the document file after the peripheral device 50 is disconnected from the computer host 12 through a hot swap manner.

As mentioned above, the OS run by the computer host 12 can successfully support the WLAN module 58, only after all of the steps shown in FIG. 4 are completed. In other words, the OS is capable of loading a corresponding device driver from the hard disk drive 26 according to related registry codes recorded in the registry file. If the user later connects the peripheral device 50 to the computer host 12 through the well-known hot swap manner, and the user only wants to utilize the WLAN module 58 to expand functionality of the computer host 12, the user switches the switch 62a on to pass the enabling signal EN1 to the power controller 60, and switches the switch 62b off to block the enabling signal EN2 from being delivered to the power controller 60. When the port 52 of the peripheral device 50 is electrically connected to either the port 32a or the port 32b, the power controller 60 does not output the driving voltage V2 to the personal disk 56 because the enabling signal EN2 is not inputted into the power controller 60. That is, the personal disk 56 does not work successfully, and does not consume any power. Therefore, the overall power consumption of the peripheral device 50 is then reduced. In the preferred embodiment, the computer host 12 supplies the operating voltage Vcc for the peripheral device 50. If the computer host 12 is a portable device such as a notebook computer or a personal digital assistant, a battery device is mainly used to drive the voltage levels. With the reduction of the power consumption of the peripheral device 50, the operating time of the computer host 12 available to the user is accordingly increased.

Similarly, if the user later connects the peripheral device 50 to the computer host 12 through the well-known hot swap manner, and the user only wants to utilize the personal disk 56 to expand functionality of the computer host 12, the user switches the switch 62a off to block the enabling signal EN1 from being delivered to the power controller 60, and switches the switch 62b on to pass the enabling signal EN2 to the power controller 60. When the port 52 of the peripheral device 50 is electrically connected to either the port 32a or the port 32b, the power controller 60 does not output the driving voltage V1 to the WLAN module 58 because the enabling signal EN1 is not inputted into the power controller 60. Therefore, the WLAN module 58 is unable to work successfully, and does not consume any power. In other words, the overall power consumption of the peripheral device 50 is then reduced.

The peripheral device 50 has switches 62a, 62b set by the user to control whether the personal disk 56 and the WLAN module 58 are workable. In other words, when the switch 62a is turned on, and the switch 62b stays off, the peripheral device 50 functions as a stand-alone WLAN module 58. Similarly, when the switch 62b is turned on, and the switch 62a stays off, the peripheral device 50 functions as a stand-alone personal disk 56. However, when both switches 62a, 62b are switched on, the peripheral device 50 functions as a multi-functional device that supports data storage and wireless network access. In addition, the peripheral device 50 contains one USB hub controller 54. Therefore, the personal disk 56 and the WLAN module 58 shares the same data channel 68a with the help of the USB hub controller 54, and only one port 52 is required to connect one of the ports 32a, 32b on the computer host 12. The peripheral device 50 is capable of expanding functionality of the computer host 12 with the personal disk 56 and the WLAN module 58. However, the inserted peripheral device 50 occupies only one port on the computer host 12. Therefore, the claimed peripheral device 50 also makes more ports of the computer host 12 available to other external devices.

The circuit structure of the preferred embodiment is applied to a USB bus. However, the circuit structure of the preferred embodiment can be applied to other buses used by peripheral devices. Taking the IEEE1394 bus as an example, the port 52 can be replaced by an IEEE1394-compatible male connector, and the USB hub controller 54 can be replaced by an IEEE1394 hub controller. Then, the amended circuit structure is capable of transmitting and receiving data via the IEEE1394 bus. In addition, the personal disk 56 is used to provide the WLAN module 58 with an appropriate device driver. However, the personal disk 56 can be applied to provide other peripheral devices with appropriate device drivers. For example, the personal disk 56 is installed on a printer, and the device driver 70 stored by the memory 66 is a device driver for the printer. As mentioned above, currently popularized operating systems such as Win 2000® and WinXP® support the personal disk 56, and have an embedded software driver for the personal disk 56. Therefore, data stored in the personal disk 56 can be retrieved successfully. Similarly, when the OS detects that the connected printer is a new hardware component, the OS reads and loads the device driver 70 corresponding to the printer from the personal disk 56. Then, the OS is capable of controlling the operation of the added printer.

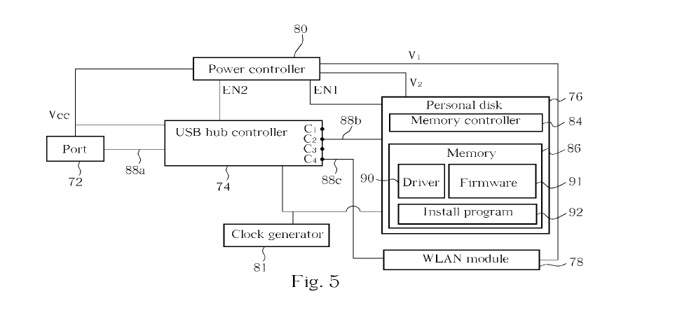

Please refer to FIG. 5, which is a block diagram of the second embodiment of the peripheral device according to the present invention. The peripheral device 50 comprises a port 72, a USB hub controller 74, a personal disk 76, a WLAN module 78, a power controller 80, and a clock generator 81. The personal disk 76 comprises a memory 86 and a memory controller 84. Further, an install program 92, a driver 90 corresponding to the WLAN module 78 and a firmware 91 corresponding to the personal disk 76 are stored in the memory 86. Please note that the devices with the same name in FIG. 3 and FIG. 5 have the same function and operation and thus detailed description is omitted here. In this embodiment, for the personal disk 76, the firmware 91 can drive the memory controller 84 to simulate an autorun function of an optical disc drive for loading the driver 90 stored in the memory 86. Additionally, when the operating voltage Vcc is inputted to the USB hub controller 74, the USB hub controller 74 outputs an enable signal EN2 to the power controller 80. In this embodiment, if the power controller 80 only receives the enable signal EN2, the power controller 80 only outputs the driving voltage V2 to the personal disk 76. However, the power controller 80 doesn't output the driving voltage V1 to the WLAN module 78. That means only when the power controller 80 receives enable signal EN1 and enable signal EN2, the power controller 80 respectively outputs the driving voltage V1 to the WLAN module 78 and the driving voltage V2 to the personal disk 76. As shown in FIG. 5, the enable signal EN1 is outputted by the personal disk 76. The situation of outputting the enable signal EN1 will be explained later.

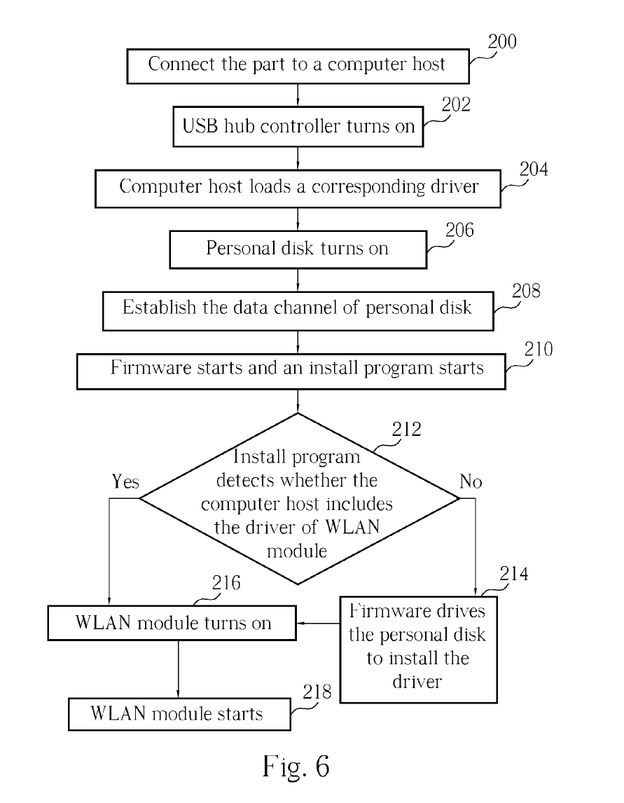

Please refer to FIG. 1 in conjunction with FIGS. 5 and 6. FIG. 6 is a flow chart illustrating operation of the peripheral device shown in FIG. 5. The operation of the peripheral device 50 in this embodiment is described as follows. The peripheral device 50 can be installed on the computer host 12 such as a desktop computer, a notebook computer, or a personal digital assistant to expand functionality of the original computer host 12. When the peripheral device 50 is connected to the computer host 12 (step 200) through the connection of port 72 and to the port 32a and 32b of the computer host 12, the computer host 12 outputs the operating voltage Vcc to the USB hub controller 74 and the power controller 80 for starting the USB hub controller 74 and the power controller 80 (step 202). With regard to the power controller 80, because the USB hub controller 74 does not trigger the enable signals EN1 and EN2 yet, the power controller 80 doesn't output the driving voltage V1 and V2 (driving voltages V1 and V2 are equal to the operating voltage here). After the USB hub controller 74 is turned on, the data channel 88a is established between the USB hub controller 74 and the USB host controller 30 for transmitting data. For instance, the USB hub controller 74 delivers hardware parameters to the USB host controller 30 so that the OS run on the computer host 12 is capable of detecting the added USB hub controller 74. Generally speaking, current operating systems such as Win 2000® and WinXP® already include the device driver of the USB hub controller 74. Therefore, the device driver of the USB hub controller 74 is successfully loaded to control the operation of the USB hub controller 74 (step 204). Because the operating voltage Vcc has been inputted into the USB hub controller 74 to activate the USB hub controller 74, the USB hub controller 74 starts triggering the enabling signal EN2 to drive the power controller 80 for outputting the driving voltages V2 to the personal disk 76 (step 206). Please note that the driving voltage V1 is not inputted to the WLAN module 78 because the personal disk 76 doesn't output the enable signal EN1 yet.

And then the personal disk 76 and the data channel 88b are established first (step 208). Therefore the OS run on the computer host 12 can detect the personal disk 76. Generally speaking, current operation system such as Win2000 and Win XP already include the driver of the personal disk 76 so that the OS can easily load the driver. In addition, because the personal disk 76 already receives the driving voltage V2, the firmware 91 is executed to control the personal disk 76. As in the above, when the personal disk 76 starts to operate, the firmware 91 drives the personal disk 76 to simulate an autorun function of an optical disc drive so that the computer host 12 can execute the install program 92 through the autorun function (step 210). The install program 92 first detects whether the computer host 12 includes the driver of the WLAN module 78 (step 212). If the computer host 12 includes the driver of the WLAN module 78, the install program 92 tells the firmware 91, used for driving the personal disk 76, to output the enable signal EN1 (step 216). Because the power controller 80 receives the enable signals EN1 and EN2, the power controller 80 outputs the driving voltage V1 to the WLAN module 78. And then the WLAN module 78 starts to operate and the computer host 12 can utilize the loaded driver to drive the WLAN module 78 to perform a predetermined operation through the data channel 88c. On the other hand, if the computer host 12 doesn't include the driver of the WLAN module 78, the install program 92 tells to the firmware 91, used for driving the personal disk 76, to output the driver 90 to the computer host 12 so that the computer host 12 can easily load the driver 90 corresponding to the WLAN module 78 (step 216) so that the WLAN module starts to operate and the computer host 12 can utilize the driver 90 provided by the personal disk 76 to drive the WLAN module to perform a predetermined operation through the data channel 88c (step 218).

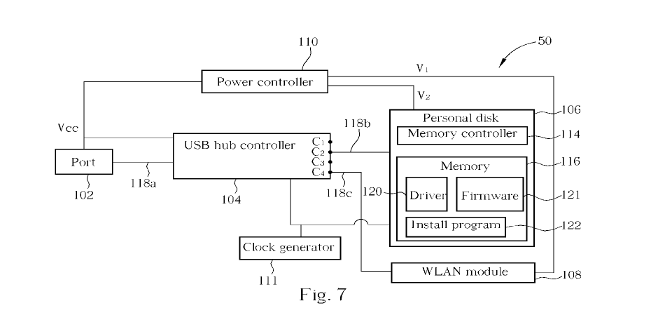

Please refer to FIG. 7, which is a block diagram of the third embodiment of the peripheral device according to the present invention. The peripheral device 50 includes a port 102, a usb controller 104, a personal disk 106, a WLAN module 108, a power controller 110, and a clock generator 111. The personal disk 106 has a memory controller 114 and a memory 116. Furthermore, an install program 122, a driver 120 corresponding to the WLAN module 108 and a firmware 121 corresponding to the personal disk 106 are stored in the memory 116. Please note that the devices having the same name have the same function and operation and thus further description is omitted here. In this embodiment, with regard to the personal disk 106, the firmware 121 can similarly drive the memory controller 114 to simulate an autorun function of an optical disc drive for loading the driver 120 stored in the memory 116.

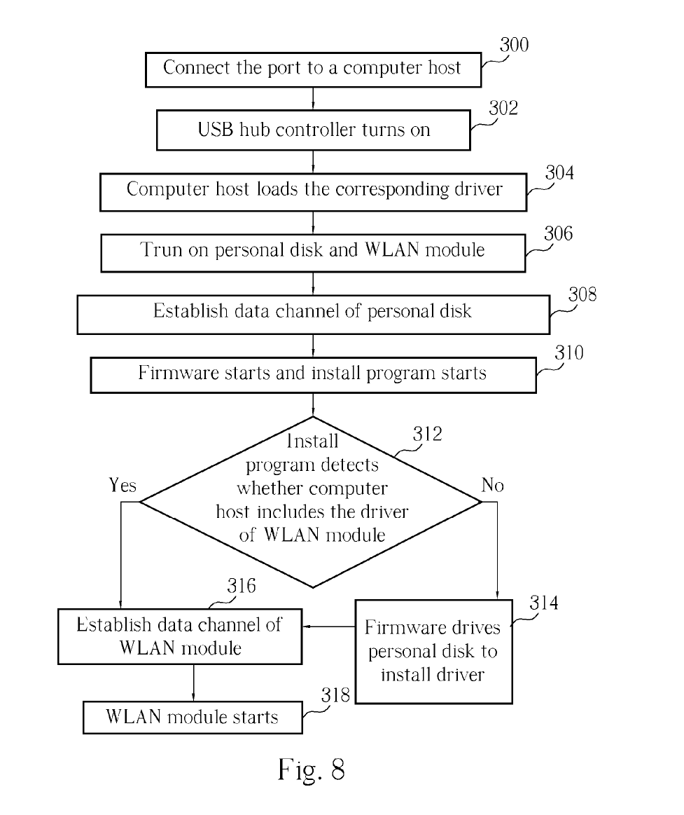

Please refer to FIG. 1 in conjunction with FIGS. 7 and 8. FIG. 8 is a flow chart illustrating operation of the peripheral device shown in FIG. 7. The operation of the peripheral device 50 in this embodiment is described as follows. The peripheral device 50 can be installed on the computer host 12 such as a desktop computer, a notebook computer, or a personal digital assistant to expand functionality of the original computer host 12. When the peripheral device 50 is connected to the computer host 12 (step 300) through the connection of port 102 to the port 32a or 32b of the computer host 12m, the computer host outputs the operating voltage Vcc to the USB hub controller 104 and the power controller 110 for starting the USB hub controller 104 and the power controller 110 (step 302). After the USB hub controller 104 is turned on, the data channel 118a is established between the USB hub controller 104 and the USB host controller 30 for transmitting data. For instance, the USB hub controller 104 delivers hardware parameters to the USB host controller 30 so that the OS run on the computer host 12 is capable of detecting the added USB hub controller 104. Generally speaking, current operating systems such as Win 2000® and WinXP® already include a device driver for a USB hub controller 104. Therefore, the device driver of the USB hub controller 104 is successfully loaded to control the operation of the USB hub controller 104 (step 304). Please note the power controller 110 outputs the driving voltage V1 and V2 (the driving voltage V1 and V2 are equal to the operating voltage Vcc) to the personal disk 106 and WLAN module 108 when the power controller 110 starts. Although the driving voltage V1 and V2 are respectively inputted to the personal disk 106 and WLAN module 108, the data channel 118b between the personal disk 106 and the USB hub controller 104 is not established and the data channel between the WLAN module 108 and the USB hub controller 104 is not established. In other words, the USB hub controller 104 doesn't start the I/O ports C2 and C4, which respectively correspond to the personal disk 106 and WLAN module 108.

In this embodiment, the USB hub controller 104 supports only 4 input/output ports (I/O ports) C1, C2, C3, C4. As known by those skilled in the art, the USB hub controller 104 starts the 4 I/O ports in order. In other words, the USB hub controller 104 first starts the I/O port C1 and establishes the corresponding data channel between the USB hub controller 104 and the device connected to the I/O port C1. Then the USB hub controller 104 starts the I/O port C2 and establishes the corresponding data channel between the USB hub controller 104 and the device connected to the I/O port C2. Until finally, the USB hub controller 104 starts the I/O port C4 and establishes the corresponding data channel between the USB hub controller 104 and the device connected to the I/O port C4. In this embodiment, the personal disk 106 is connected to the I/O port C2 and the WLAN module 108 is connected to the I/O port C4 meaning that the USB hub controller 104 starts the I/O port C2 and establishes the data channel 118b between the USB hub controller 104 and the personal disk 106 first (step 308). Therefore the OS run on the computer host 12 can detect the personal disk 106. Generally speaking, current operating systems such as Win2000 and Win XP already include a driver for the personal disk 106 meaning that the OS can easily load the driver. In addition, because the personal disk 106 already receives the driving voltage V2, the firmware 121 is executed to control the personal disk 106. As in the above, when the personal disk 106 starts to operate, the firmware 121 drives the personal disk 106 to simulate an autorun function of an optical disc drive so that the computer host 12 can execute the install program 122 through the autorun function (step 310). The install program 122 first detects whether the computer host 12 includes the driver of the WLAN module 108 (step 312). If the computer host 12 includes the driver of the WLAN module 108, the install program 122 tells the USB hub controller 104 to start the I/O port C4 and establishes the corresponding data channel (step 316) so that the WLAN module starts to operate and the computer host 12 can utilize the loaded driver to drive the WLAN module 108 to perform a predetermined operation (step 318). On the other hand, if the computer host 12 doesn't include the driver of the WLAN module 108, the install program 122 tells the firmware 121 to drive the personal disk 106 to output the driver 120 to the computer host 12. Therefore the computer host 12 can easily load the driver 120 corresponding to the WLAN module 108 (step 314). And then the install program 122 tells the USB hub controller to start the I/O port C4 and the corresponding data channel (step 316) so that the WLAN module 108 starts to operate and the computer host 12 can utilize the driver 120 provided by the personal disk 106 to drive the WLAN module 108 to perform a predetermined operation (step 318).

The circuit structure of the preferred embodiment is applied to a USB bus. However, the circuit structure of the preferred embodiment can be applied to other buses used by peripheral devices. Taking the IEEE1394 bus for example, the port (52, 72, 102) can be replaced by an IEEE1394-compatible male connector, and the USB hub controller (54, 74, 104) can be replaced by an IEEE1394 hub controller or a bridge to USB. The amended circuit structure is then capable of transmitting and receiving data via the IEEE1394 bus. In addition, the personal disk (56, 76,106) is used to provide the WLAN module (58, 78, 108) with appropriate device drivers. However, the personal disk (56, 76, 106) can be applied to provide other peripheral devices with an appropriate device driver. For example, the personal disk (56, 76, 106) is installed on a printer, and the device driver (70, 90, 120) stored by the memory (66, 86, 116) is a device driver for the printer. As mentioned above, currently popularized operating systems such as Win 2000® and WinXP® support the personal disk (56, 76,106) and have an embedded software driver for the personal disk (56, 76, 106). Therefore, data stored in the personal disk (56, 76, 106) can be retrieved successfully. Similarly, when the OS detects that the connected printer is a new hardware component, the OS reads and loads the device driver (70, 90, 120) corresponding to the printer from the personal disk (56, 76, 106). Then, the OS is capable of controlling the operation of the added printer.

The personal disk (56, 76, 106) mentioned above is viewed as a storage device for storing any formats of data such as installation files of device drivers, installation files of applications, and document files. When the personal disk (56, 76, 106) is combined with an application module such as the WLAN module (58, 78, 108) shown in FIG. 3 or the above-mentioned printer, and the personal disk (56, 76, 106) and the application module are positioned inside the peripheral device 50, the personal disk (56, 76, 106) can be used to store any data generated during the operation of the application module. For example, suppose that the application module is a GPS module used for receiving a plurality of orientation signals and converting the orientation signals into a corresponding coordinate value. The personal disk 56 not only stores a software driver of the GPS module, but also is used to store a map file, an e-MAP navigator application, and manuals of the GPS module and the e-MAP navigator application. When the peripheral device 50 is installed on the computer host 12, the device driver stored on the personal disk is retrieved by the computer host 12 to drive the newly added GPS module. Then, the computer host 12 utilizes the personal disk (56, 76, 106) to install the e-MAP navigator application. In the end, the computer host 12 runs the e-MAP navigator application to display a current location of the computer host 12 on the monitor 28 shown in FIG. 1 through the coordinate value provided by the GPS module and the map file provided by the personal disk (56, 76, 106). To sum up, the personal disk (56, 76, 106) does not merely store device drivers. With regard to the application modules inside the peripheral device 50, the personal disk (56, 76, 106) is capable of storing device drivers, software applications, and manuals corresponding to the application modules. Therefore, the total amount of used optical disks, used magnetic disks, and used paper are greatly reduced.

In contrast to the prior art, the claimed peripheral device combines a personal disk and an application module. Therefore, when the user carries the claimed peripheral device, a device driver of the application module travels along with the application module. When the claimed peripheral device is connected to a computer host, the computer host is capable of retrieving and loading the device driver stored by the personal disk to correctly drive the added application module to perform a predetermined operation. Therefore, the inconvenience caused by the device driver being stored on an optical disk or a magnetic disk is solved. In addition, the personal disk itself is a storage device, and a manual of the application module or software applications of the application module can be stored on the personal disk. Therefore, consumption of optical disks, magnetic disks, and paper is reduced. At the same time, the cost is accordingly lowered. Furthermore, the claimed peripheral device has a hub controller so that both the personal disk and the application module share the same port. Therefore, the computer host is capable of having more ports available to other external devices. The claimed peripheral device also has switches used for control power supply of the personal disk and the application module according to user's demands so that the power consumption associated with the claimed peripheral device is greatly reduced.

Those skilled in the art will readily observe that numerous modifications and alterations of the device may be made while retaining the teachings of the invention. Accordingly, the above disclosure should be construed as limited only by the metes and bounds of the appended claims.

1. A peripheral device capable of being connected to an interface port on an electronic device host, the peripheral device comprising:
a housing;
an application module positioned at least partially inside the housing;
a storage module positioned inside the housing for storing a device driver of the application module and a firmware that can drive the storage module to simulate an autorun function of an optical disc drive; and
a hub controller positioned inside the housing, the hub controller being electrically connected to the application module and the storage module;
wherein when the hub controller is electrically connected to the interface port, the electronic device host is capable of retrieving the device driver stored by the storage module and running the device driver to operate the application module.

2. The peripheral device of claim 1 further comprising a power controller electrically connected to the storage module and the application module for controlling whether a predetermined voltage is delivered to the storage module to enable the storage module and controlling whether the predetermined voltage is delivered to the application module to enable the application module.

3. The peripheral device of claim 2 wherein when the hub controller starts to operate, the power controller delivers a predetermined voltage to the storage device and stops delivering the predetermined voltage to the application device.

4. The peripheral device of claim 3 wherein if the firmware detects that the electronic device host comprises a driver, the firmware can send a control signal to the power controller for driving the power controller to deliver the predetermined voltage to the application device.

5. The peripheral device of claim 3 wherein if the firmware doesn't detect that the electronic device host comprises a driver, the firmware can drive the storage device to execute the autorun function to install the driver of the electronic device host.

6. The peripheral device of claim 5 wherein if the driver is installed in the electronic device host, the firmware can send a control signal to the power controller for driving the power controller to deliver the predetermined voltage to the application device.

7. The peripheral device of claim 2 wherein the predetermined voltage is outputted from the electronic device host through the interface port.

8. The peripheral device of claim 1 wherein the interface port is a CardBus port, and the hub controller is a bridge circuit that is used for bridging a CardBus and a USB.

9. The peripheral device of claim 1 wherein the interface port is a CardBus port, and the hub controller is a bridge circuit that is used for bridging a CardBus and an IEEE1394 bus.

10. A method of driving a peripheral device, the peripheral device capable of being connected to an interface port on an electronic device host and comprising an application module, a storage module, and a hub controller, and the method comprising:
connecting the peripheral device and the interface port;
enabling the hub controller for controlling data transmission among the application module, the storage module, and the electronic device host;
enabling the storage module;
simulating an autorun function of an optical disc drive to install the driver of the application device in the electronic device host by having the storage device execute the firmware to drive the storage device for; and
running the device driver to operate the application module.

11. The method of claim 10 further comprising:
controlling whether a predetermined voltage is delivered to the storage module to enable the storage module; and
controlling whether the predetermined voltage is delivered to the application module to enable the application module.

12. The method of claim 11 wherein the predetermined voltage is outputted from the electronic device host through the interface port.

13. The method of claim 11 further comprising:
delivering the predetermined voltage to the storage device and stopping delivering the predetermined voltage to the application device when the hub controller starts.

14. The method of claim 13 further comprising:
starting to deliver the predetermined voltage to the application device after the firmware detects that the electronic device host comprises the driver.

15. The method of claim 13 further comprising:
driving the storage device to execute the autorun function for installing the driver in the electronic device host if the firmware doesn't detect that the electronic device host comprises the driver.

16. The method of claim 13 further comprising:
starting to deliver the predetermined voltage to the application device after the driver is installed in the electronic device host.

17. The method of claim 10 wherein the interface port is a CardBus port, and the hub controller is a bridge circuit that is used for bridging a CardBus and a USB.

18. The method of claim 10 wherein the interface port is a CardBus port, and the hub controller is a bridge circuit that is used for bridging a CardBus and an IEEE1394 bus.

19. A peripheral device capable of being connected to an interface port of an electronic device host, the peripheral device comprising:
a connector having a plurality of pins for connecting the interface port of the electronic device host;
a hub controller electrically connected to the connector;
an application module electrically connected to the hub controller; and
a storage module electrically connected to the hub controller for storing data, the storage module comprising:
a storage unit used for storing a firmware that can drive the storage module to simulate an autorun function of an optical disc drive to install the driver in the electronic device host.

20. A peripheral device capable of being connected to an interface port of a host, the peripheral device comprising:
a connector having a plurality of pins for connecting the interface port of the host;
a hub controller electrically connected to the connector; and
a storage module electrically connected to the hub controller for storing data, the storage module comprising:
a storage unit used for storing a firmware that can drive the storage module to simulate an autorun function of an optical disc drive, and the host can automatically run the driver from the storage module through the autorun function;
wherein the storage module stores a device driver of the peripheral device in advance, and the host retrieves the device driver from the storage module when the peripheral device is connected to the interface port for a first time.
